(19) United States
(12) Patent Application Publication
(10) Pub. No.: US 2008/0210832 A1
(43) Pub. Date: Sep. 4, 2008

(54) Support For Video/Photographic Equipment

(75) Inventor: Paolo Speggiorin, Mussolente (VI) (IT)

Correspondence Address: RATNERPRESTIA, P O BOX 980, VALLEY FORGE, PA, 19482-0980, US

(73) Assignee: LINO MANFROTTO + CO. S.P.A., Bassano Del Grappa (IT)

(21) Appl. No.: 11/914,611

(22) PCT Filed: May 5, 2006
(86) PCT No.: PCT/IT2006/000320

§ 371 Date: Nov. 16, 2007

(30) Foreign Application Priority Data
May 18, 2005 (IT) PD2005A000143

(51) Int. Cl. F16M 11/14; F16C 11/06

(52) U.S. Cl. 248/183.1

(57) ABSTRACT

A support for video or photographic equipment including a ball-and-socket joint having a first and a second joint member, respectively in the form of a socket and a ball, both spherical, and rotatably coupled to each other, there being defined in the ball member a substantially equatorial meridian plane perpendicular to a panoramic axis. The support comprises first and second guide means respectively on the ball member and the socket member and selectively engageable with one another both for sliding of one with respect to the other in the equatorial circumferential direction and for relative rotation about a pivot axis lying on the equatorial plane and perpendicularly intersecting the panoramic axis in order to limit the capacity for relative rotation between the members about the panoramic axis and about the pivot axis.

### TECHNICAL FIELD

The present invention relates to a support for video/photographic equipment having the characteristics mentioned in the main claim.

### BACKGROUND

In the field of supports for photographic equipment it is known to use ball-and-socket joints which have the appreciable advantage of allowing movements for displacing the equipment in any direction with considerable rapidity. A typical example of such supports is known from U.S. Pat. No. 4,915,333. These supports, however, are not suitable to be lend themselves to being used for video equipment. A specific support for such equipment must in fact guarantee its displacement about two axes orthogonal to each other, one horizontal, termed “tilt”, with which the inclination of the equipment with respect to the horizontal is adjusted, and a vertical one, termed “panoramic”, with which the angular sighting moves along the horizon. If secure maintenance of the panoramic axis is not guaranteed, during the movement of the equipment this axis may be “lost”, with a consequent “drop” of the equipment and of the image taken, which is qualitatively unpleasing.

Besides this need to maintain the panoramic axis, a problem encountered in the production of economic supports for video equipment lies in the need to uniformly friction the movement about both said axes. For a support to be reasonably economic, it is necessary for it to be constructed with a limited number of components, and that limits the possibility of accurate control of separate frictioning for the panoramic and tilt axes. On the other hand, ball-and-socket joints have the prerogative of guaranteeing substantially constant frictioning for all the displacement movements.

### DESCRIPTION OF THE INVENTION

The invention proposes as the principal technical problem that of providing a support suitable for both video and photographic equipment, structurally and functionally designed to make it possible to remedy all the drawbacks mentioned with reference to the prior art cited.

This problem is solved by the invention with a support produced according to the following claims.

### BRIEF DESCRIPTION OF THE DRAWINGS

The characteristics and advantages of the invention will become clearer from the detailed description of a preferred, but not exclusive, exemplary embodiment thereof, illustrated by way of non-limiting example with reference to the appended drawings, in which:

FIG. 1 is a view in longitudinal section of a support produced according to the present invention;

FIGS. 2 and 3 are views in cross-section along the line II-II of FIG. 1, referring to the same support in two different operative states;

FIG. 4 is a perspective view with partial section of the support of FIG. 1;

FIG. 5 is a sectional view on an enlarged scale of the detail indicated by the arrow A in FIG. 4;

FIG. 6 is a perspective view of the support of the preceding figures in the portrait position.

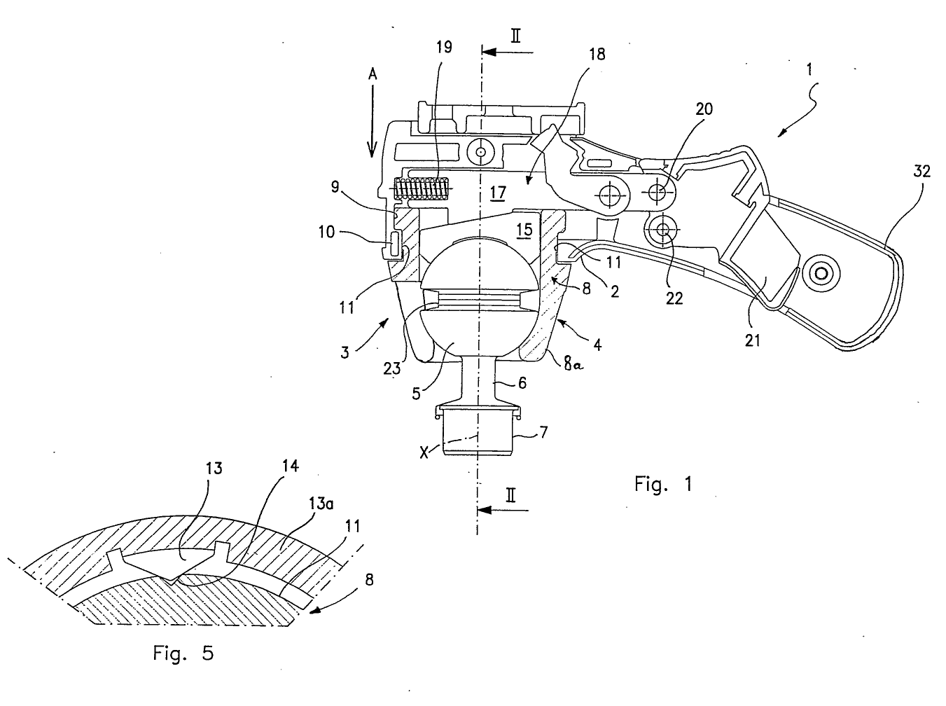

### PREFERRED WAY OF IMPLEMENTING THE INVENTION

In the drawings, the reference 1 indicates as a whole a support for video and photographic equipment produced according to the present invention.

The support 1 comprises a body 2 in which is mounted a ball-and-socket joint 3 comprising a first joint member 4 in the form of a socket for a ball, and a second joint member in the form of a ball 5. The ball 5 is in turn connected by means of a stem 6 to a threaded connector 7 for coupling to a tripod or the like.

The first joint member 4 comprises a substantially cylindrical collar 8 rotatably mounted in a seat 9 of the body 2, where it is held axially by the effect of the mutual engagement between an annular track 11 provided in its outer wall and a circumferential bead 10 in relief on a corresponding seat of the body 2.

The collar 8, on the part axially opposed to the track 11, has a terminal portion 8a having an internal configuration in the form of a rounded seat (socket for the ball) the spherical course of which is capable of mating with the corresponding surface of the ball 5. A runner 15 is resiliently urged against the surface of the ball 5 opposed to the terminal portion 8a for frictioning of the joint 3. The runner 15 is urged against the ball by springs 16 and by the thrust component determined by a wedge 17 which belongs to a slider indicated as a whole by 18, guided on the runner 15 between shoulders 15a, 15b of same. The wedge 17 is coupled to the runner 15 with an inclined plane coupling. The slider 18 is resiliently urged by springs 19 so as to press the runner 15 forcibly against the ball 5 for the locking of the joint, and is articulated at a pin 20 to a trigger 21 which is in turn hinged at 22 to the inside of a handgrip 32 extending radially from the body 2 to allow the operation of orientation of the support 1.

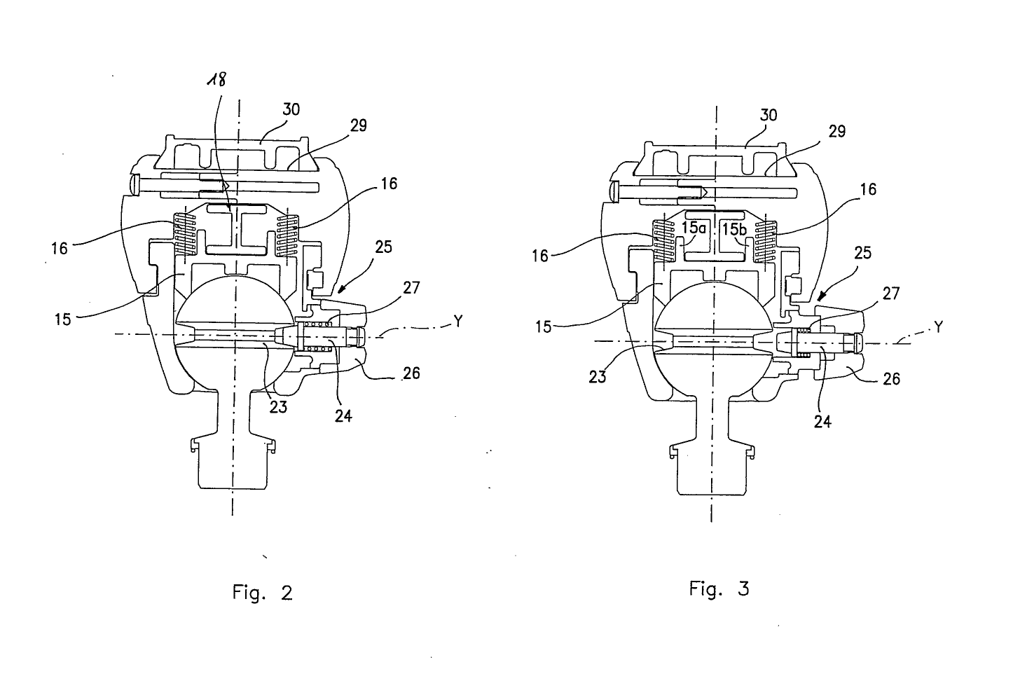

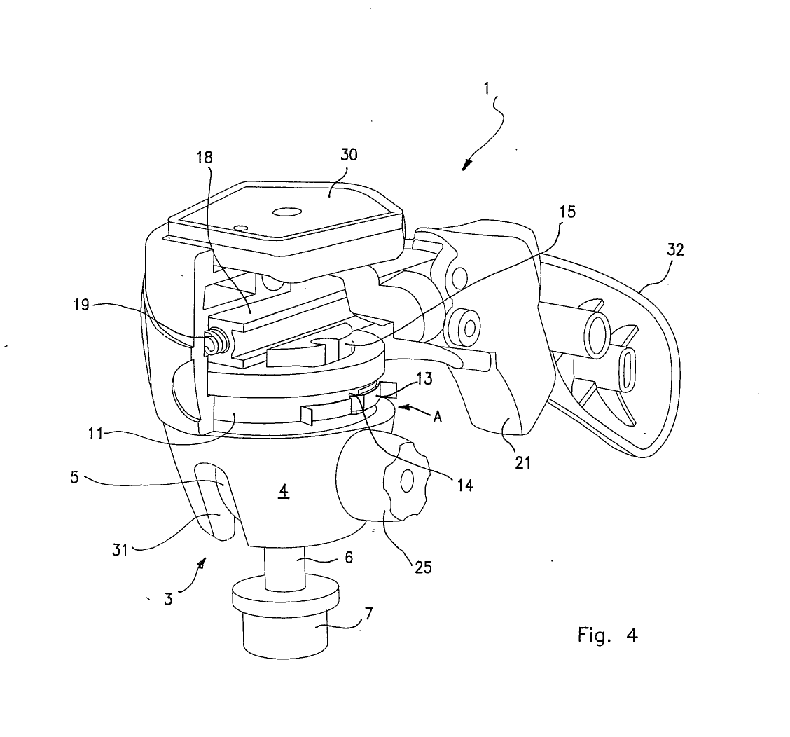

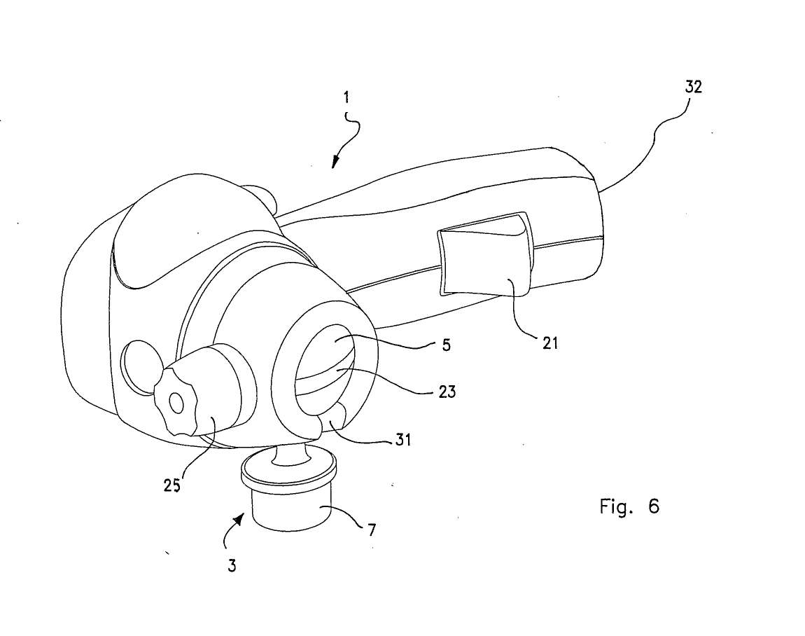

In the ball 5 an equatorial meridian plane is identified, passing through a maximum circumference and perpendicular to a panoramic axis X which substantially coincides with the axis of the stem 6. At the equatorial meridian plane an annular groove 23 is provided which is removably engageable by a plunger 24 mounted on the body 2 and movable, by means of a cam control 25 with actuating knob 26 and in opposition to a spring 27, between a first operative position in which it is engaged in the groove 23 (FIG. 2) and a second position in which it is removed from the groove 23 (FIG. 3). The groove 23 and plunger 24 are configured such that the ball is rotatable about the axis Y of the plunger when this latter is engaged in any position in said groove and in addition a guided coupling exists between groove and plunger so that the joint members can rotate with respect to one another about the panoramic axis X when the plunger is engaged in the groove.

For this reason, in the following claims reference will be made to the groove and plunger also by the terms first and second guide means.

Because the ball is rotatable about the axis Y of the plunger when this latter is engaged in the groove, it is necessary for the terminal part of the plunger, in addition to being rounded (in the present instance, conical, if the groove is tapered in a V-shape) and capable of sliding with respect to the groove in the equatorial circumferential direction, also to be aligned with a pivot axis (Y) lying on the equatorial plane and perpendicularly intersecting the panoramic axis X. In this way the capacity for relative rotation between the joint members about the panoramic axis and about the pivot axis is limited.

On an upper surface of the body 2, a recess 29 is provided in which is removably received in a snap engagement a small plate 30 for rapid attachment of the preselected video or photographic equipment.

The relative positioning between the collar 8 and the body 2 comprises a predetermined reference positioning determined by the resilient snap engagement of a small tooth 13, provided on a plate spring 13a fixed to the body 2, in a recess 14 of the collar 8, which engagement is easily overcome by forcing the relative rotation of the body 2 with respect to the collar 8.

In that state the collar 8 is oriented with respect to the handgrip 32 in such a way that this latter is diametrically opposite a notch 31 extending in the outer wall of the collar 8. The extent and orientation of the notch 31 is such as to permit the passage of the stem 6 of the ball so as to bring the handgrip into a state of substantial alignment with the panoramic axis X. In this state the support is arranged for the portrait function or makes it possible to rotate the camera mounted thereon through 90°, also with a capacity for orientation in a panoramic plane, coinciding with the equatorial plane of the ball previously defined, and about a tilt axis, coinciding with the axis of the coupling between the annular track 11 and the annular bead 10. In the portrait position, the displacement about the tilt axis is obtained by relative sliding between the bead 10 and the track 11.

When it is desired to return from the portrait position to the preceding one it is sufficient to bring the relative positioning between the body 2 and the collar 8 into a state such that the tooth 13 snaps into the recess 14 so as to guarantee that the notch 31 is on the diametrically opposite side from the handgrip 32 and can easily be disengaged from the stem 6.

The functioning of the support of this invention is as follows: using video equipment, the knob 26 is rotated in such a way that the plunger 24 is engaged in the annular groove 23 so as to maintain steady positioning of the panoramic axis. The tilt displacement is effected by releasing the ball joint by means of pressure on the trigger 21.

For use with photographic equipment, the ball is freed for complete movement with respect to the collar. This is achieved by rotating the knob 26 in such a way that the plunger 24 is disengaged from the annular groove 23. Finally, for the portrait function, the knob 26 is rotated in such a way that the plunger 24 is once again engaged in the annular groove 23 and the use is that just illustrated.

The invention thus solves the problem proposed, obtaining numerous advantages, including perfect ambivalence, satisfying both the typical needs of photographic use and those of video shooting, suitability for being used for portrait-type photographs, and it also lends itself to a particularly compact and economic construction.

1. A support for video or photographic equipment including a ball-and-socket joint having a first and a second joint member, respectively in the form of a socket and a ball, both spherical, and rotatably coupled to each other, there being defined in said ball member a substantially equatorial meridian plane perpendicular to a panoramic axis, said support comprising first and second guide means respectively on the ball and socket members and selectively engageable with one another both by sliding of one with respect to the other in the equatorial circumferential direction and by relative rotation about a pivot axis lying on said equatorial plane and perpendicularly intersecting said panoramic axis in order to limit the capacity for relative rotation between said members about the panoramic axis and about said pivot axis, wherein the first and second guide means comprise a circumferential groove in said ball member and a plunger on said socket members, said plunger and said groove being configured so that said ball is rotatable about the pivot axis of said plunger when this latter is engaged in any position in said groove, said plunger is being resiliently urged into engagement with said groove and cam means being provided between said plunger and said socket for selectively holding the plunger in a state of disengagement from said groove.

2. A support for video or photographic equipment according to claim 1, comprising a handgrip extending, with respect to said socket members, in a direction substantially perpendicular to said pivot axis.

3. A support for video or photographic equipment according to claims 2, comprising frictioning means between said joint members for locking said members to one another by friction.

4. A support for video or photographic equipment according to claim 2, comprising a body having said handgrip and in which is housed said joint with said spherical socket member including a substantially cylindrical collar held axially in said body but rotatable with respect thereto.

5. A support for video or photographic equipment according to claim 4, wherein, in said collar, a notch is provided, capable of receiving a stem of said spherical ball member, means being provided on said collar and said body in order to effect a predetermined positioning between said collar and said body corresponding to a predetermined positioning of said handgrip relative to said notch.

6. A support for video or photographic equipment according to claim 4, wherein said collar is held in a seat of said body by means of mutual engagement of a circumferential bead in relief on said seat with an annular track provided on said collar.

7. A support for video or photographic equipment according to claim 3, wherein said frictioning means comprise a runner resiliently urged against said ball member.

8. A support for video or photographic equipment according to claim 7, wherein said runner is also urged against said ball member by the thrust component of a wedge coupled to said runner by means of an inclined plane coupling and subject to resilient action.

9. A support for video or photographic equipment according to claim 8, wherein said wedge is firmly connected in translation with a slider guided on the runner and actuated in translation in the direction of release of the inclined plane coupling by means of a trigger in opposition to the resilient action of a spring means.
